(19) United States
(12) Patent Application Publication
(10) Pub. No.: US 2007/0024963 A1
(43) Pub. Date: Feb. 1, 2007

(54) Method of observing defect and observation apparatus using microscope

(75) Inventors: Shusaku Maedo, Hitachinaka (JP); Kazuo Aoki, Hitachinaka (JP)

Correspondence Address: MCDERMOTT WILL & EMERY LLP, 600 13TH STREET, N.W., WASHINGTON, DC, 20005-3096, US

(73) Assignee: Hitachi High-Technologies Corporation

(21) Appl. No.: 11/482,023

(22) Filed: Jul. 7, 2006

(30) Foreign Application Priority Data
Jul. 7, 2005 (JP) JP 2005-199167

(51) Int. Cl. G02B 21/00

(52) U.S. Cl. 359/368

(57) ABSTRACT

Detection efficiency is improved by saving time for setting beforehand a detailed condition before a review work. Various conditions are automatically set on the basis of defect information sent from a defect inspection apparatus and information acquired during actual reviewing to save time for setting the detailed condition before the review work and to decide automatically and within a short time a proper condition.

### BACKGROUND OF THE INVENTION

This invention relates to a method of observing defects by using an electron microscope capable of observing a fine measurement object existing on a sample surface. More particularly, the invention relates to a method of observing defects by transforming coordinate data of defects on a sample measured by other defect/foreign matter inspection apparatus so that the data can be adapted to the coordinate system of its own.

An electron microscope has been used in diversified research and development fields for observing fine structures of samples. The electron microscope displays an SEM (Scanning Electron Microscope) image of the observation object observed on a display screen. This technology has also been applied to the observation of fine structures of semiconductor devices. As miniaturization of the semiconductor devices has proceeded in recent years, the semiconductor devices are fabricated at present into a pattern width of 150 nm or below. In such semiconductor devices, troubles may occur if foreign maters/defects having a size of about dozens of nm exist on a wafer on which the semiconductor pattern is formed. To examine in detail the foreign matters/defects as the cause of the trouble, these foreign matters/defects must be observed through the electron microscope. The foreign matters/defects will be hereinafter called generically the “defects”.

To observe such a fine defect through the electron microscope, it has been customary to measure in advance the position of the defect on the wafer by using a defect inspection apparatus such as an optical wafer appearance inspection apparatus or an SEM wafer appearance inspection apparatus that stipulates the position of the defect on the wafer with light or electrons as a probe and to search and observe the defect on the basis of the coordinate data acquired by the measurement. When a defect of about 50 nm is observed through the electron microscope, for example, it is necessary to enlarge the defect to a field of view (FOV) of at least 20,000 times and to display the image on an SEM image screen. Because the region capable of observing the images at one time is limited owing to the limit of the SEM image screen size, however, the defect swells out in some cases from the SEM image screen when the coordinate data of the defect acquired from the defect inspection apparatus greatly contains errors. When a defect is observed in magnification of 20,000 times by using an electron microscope having an SEM image display screen size of 150 mm×150 mm, for example, the region of the SEM image that can be observed at one time is only 7.5 μm×7.5 μm. When the coordinate data from the defect inspection apparatus contains an error of greater than ±3.25 μm, the defect is out of the SEM image display screen and cannot be discovered.

Because inspection processing capacity of semiconductor inspection apparatuses typified by a review SEM has been improved particularly in recent years, automatic processing of the inspection of all defects of all wafers, discrimination of these defects and data processing has been required. In the observation of the defects, in particular, the processing must be suspended or detection must be made again by moving the visual field to the periphery when the defect is out of the region of the SEM image display. In such a case, the processing needs an enormous time and a large number of wafers cannot be inspected efficiently.

For this reason, it is necessary to correct the coordinate value of the defect sent from other defect inspection apparatus by taking into consideration the errors such as the difference of the coordinate system, offset deviation of the wafers, deviation of rotation, error of dimensional accuracy of coordinate axes, and so forth. As a method of correcting the coordinate value, JP-A-11-167893 discloses a correction method including the steps of assembling in advance a correction formula incorporating a parameter for correcting each factor before the review, selecting a plurality of defects used for the correction, acquiring the coordinate value sent from the apparatus and the coordinate value on the wafer measured, deciding the parameter of the correction formula from the values and correcting all the defects on the wafer. However, the defect is out of the visual field of the microscope or is too small for detection in some cases unless the conditions such as a detection magnification are appropriately set during movement to the position of the defect to acquire the coordinate value of the defect used for correcting the coordinate value. These conditions have been set and optimized by putting many hours on the empirical and trial-and-error basis.

While no-man operation and high speed review have been required, the prior art technology involves the problem that a processing must be stopped or an enormous time is necessary for processing unless detection is made appropriately, and the defect cannot be detected efficiently within a short time. Therefore, the detailed conditions must be set with a long time before the review on the basis of the defect information acquired by the defect inspection apparatus.

### SUMMARY OF THE INVENTION

In view of the problems described above, the invention provides means for saving time for setting in advance detailed conditions before the review and automatically deciding suitable conditions within a short time by automatically deciding various conditions on the basis of defect information sent from a defect inspection apparatus and information acquired during an actual review.

In the invention for accomplishing these objects, a defect review route is automatically decided on the basis of defect information acquired from a defect inspection apparatus. Consequently, it is no longer necessary to set in advance a defect review order before the review.

An error between the defect coordinate position acquired from the defect inspection apparatus and the defect coordinate position actually acquired during the review is calculated for an effective number of points to determine a correction term of coordinate transformation. In this way, subsequent position errors are automatically corrected, and correction of the position coordinates need not be executed by observing the defect at only several or all points before the review.

The FOV on the apparatus screen is decided by the size information of the defect acquired from the defect inspection apparatus. As a result, it is not necessary to set in advance the FOV in the defect review and observation can be made in the optimal FOV suitable for each defect. The image size is similarly decided on the basis of this information. Consequently, the review need not be executed in a large size with a long time for all the defects but can be made in an optimal image size for each defect without an unnecessarily long time.

When the defect cannot be detected during the review in the FOV set under the condition described above, the periphery of the field is searched in the same FOV. In this case, the invention has the function of changing image processing parameters such as an image size, a detector, brightness, and so forth. Consequently, the defect can be again detected even when it is not caught under the set condition.

The invention can improve detection efficiency and can moreover save time for setting beforehand the detailed condition before the review.

Other objects, features and advantages of the invention will become apparent from the following description of the embodiments of the invention taken in conjunction with the accompanying drawings.

### BRIEF DESCRIPTION OF THE DRAWINGS

FIG. 1 shows the principle of the present invention and is a flowchart for automatically deciding defect coordinate correction and defect review condition of a defect observation apparatus;

FIG. 2 shows an example of a screen for displaying an instruction menu for deciding the defect review condition; and

FIG. 3 shows another example of the screen for displaying an instruction menu for deciding the defect review condition.

### DESCRIPTION OF THE INVENTION

An electron microscope according to the invention accomplishes the objects of improving detection efficiency and saving time in setting beforehand the detailed condition prior to a review work by including a condition setting portion for deciding a defect retrieving condition for each defect by using defect data from other defect inspection apparatus and information about the defect acquired during the review work.

A preferred embodiment of the invention will be hereinafter explained in detail with reference to the accompanying drawings. Though the explanation will be given on the electron microscope by way of example, the invention can also be applied to an optical imaging apparatus. In this case, images of a bright field optical system as well as images of a dark field optical system can be used. When first several specific points are selected by combining these images, it is possible to use the images of the bright or dark field optical system and to subsequently use SEM images. In this case, large offset in the first coordinate system can be corrected more efficiently and within a shorter time by using the images of an optical imaging apparatus having a broad image area. These systems can be combined in an arbitrary combination.

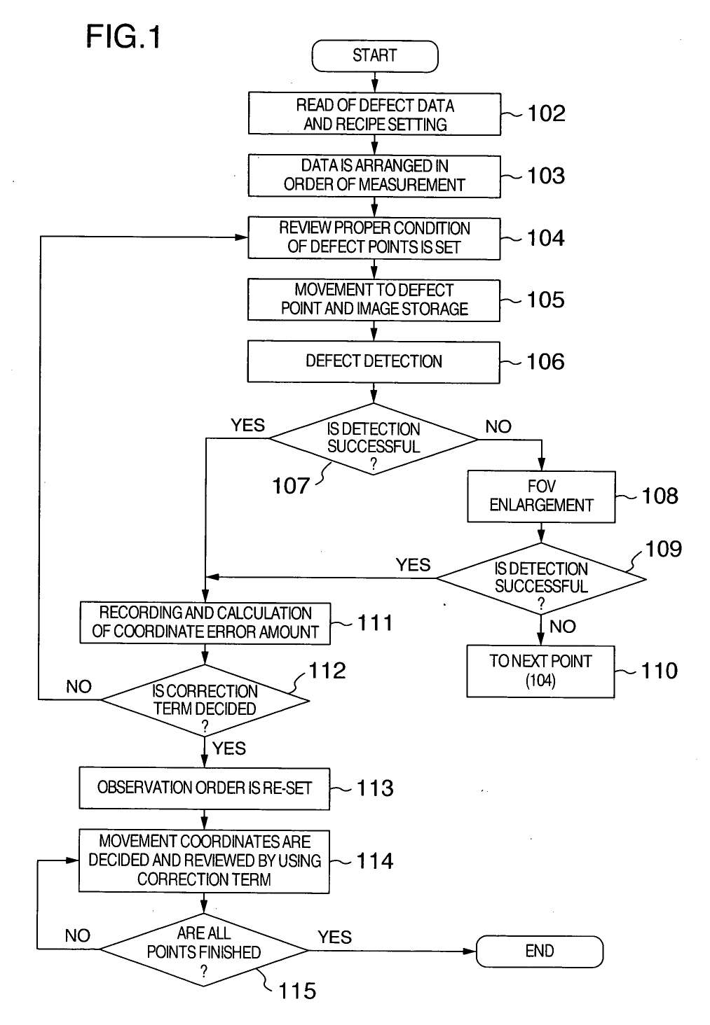

FIG. 1 is a flowchart useful for explaining a defect coordinate correction and defect review condition deciding method according to the invention. To begin with, a defect coordinate position acquired from a defect inspection apparatus is read and a recipe in defect review is set in Step 102. Here, the term “recipe” means the condition that is set when reviewing the defect on a wafer and is a combination of various observation methods so as to cope with diversified wafers, such as low/high magnification, detection mode (detection method relying on probe current, detector, etc), auto-focus mode (waving width and speed of auto-focus), number of defects to be reviewed, and so forth.

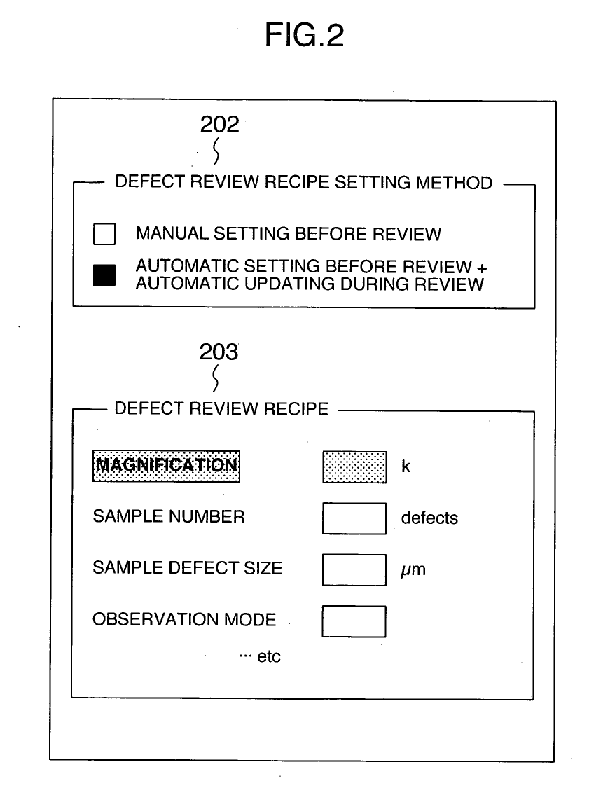

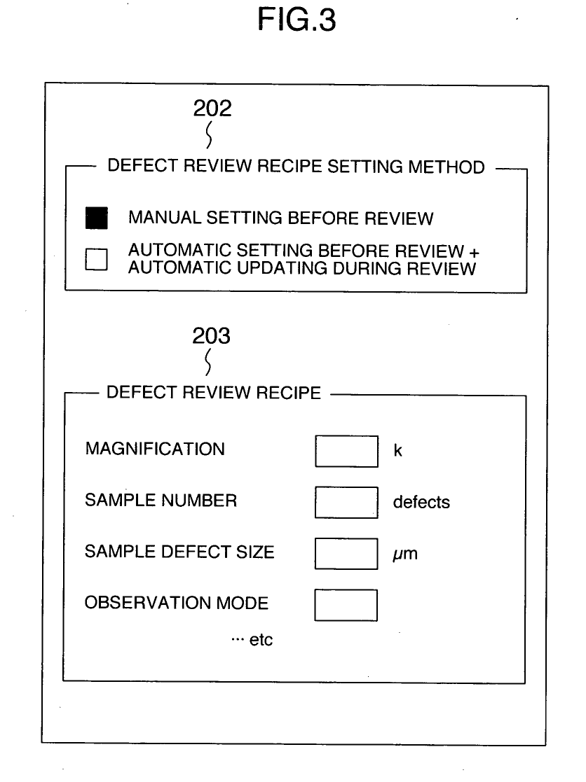

FIGS. 2 and 3 show display screens that display a selection method of the recipe condition set when the defect review operation is conducted. FIG. 2 shows the screen when the recipe is automatically set and FIG. 3 shows the screen when the recipe is manually set before reviewing. When “automatic setting before review+automatic updating during review” is selected in a selection portion 202 of the recipe setting method as shown in FIG. 2, an FOV setting portion in a defect review recipe input portion 203 changes to gray display and no input is necessary. When “manual setting before review” is selected in the selection screen 202 of the recipe setting method, on the other hand, various conditions inclusive of setting of observation magnification is inputted to the defect review recipe 203 as shown in FIG. 3.

Turning back to FIG. 1, in Step 103, the defects to be measured that are decided by recipe setting are sorted in descending order in accordance with their sizes. However, defects of 10 mm, for example, cannot be put into the visual field even when the magnification is set to the lowest magnification and the center cannot be taken. Therefore, this is not suitable for determining a substantial error. To re-align the defects in descending order according to their sizes, the maximum size is decided at the time of setting of the recipe. When the maximum size is set to 3 μm, for example, the defects below the maximum size are sorted in descending order in accordance with the sizes such as 2.9 μm, 2.8 μm, 1.5 μm and 1.0 μm, and the defects greater than the set sizes are positioned last.

The review operation is started in the next Step 104 and a review optimal condition is set to each defect point. However, magnification is indiscriminately set to 8,000 times until the correction term is decided in Step 112. Detection of the defects becomes more difficult when the magnification drops. Because the defects are sorted in descending order according to their sizes, however, the defects can be detected with a high probability.

Next, in Step 105, the flow moves to the defect on the basis of the defect position coordinates acquired from the defect inspection apparatus. Detection of the defects is made in Step 106. In the next Step 107, success/failure of defect detection is judged. When detection proves successful, the flow proceeds to Step 111 and an error between the defect coordinates acquired from the defect inspection apparatus and the position coordinates at which the defect is actually detected is recorded. When the defect detection proves failure, the FOV is enlarged in Step 108 and detection of defect is again made. Success/failure judgment of defect detection is executed in Step 109. FIG. 1 shows only enlargement of the FOV as the counter-measure when the defect detection fails, but enlargement of the image size and search-around as a periphery retrieval function can be executed. When the detectable minimum defect size is 10 nm in a certain FOV, for example, the detectable minimum defect size is 5 nm when the image size is increased to 2 times and detection of finer defects becomes possible. When search-around is executed, upper and lower and right and left eight directions are scanned and defects out of the visual field can be detected. Which of them is to be executed can be decided by recipe setting. When detection further fails in the judgment of Step 109, this detection becomes “non-detected” and the flow moves to the next defect in Step 110.

In Step 112, the correction term is decided by using the coordinate error amount calculated in Step 111. It is obvious that when the correction amount of the defect of only one point is applied to all the defect points, for example, the result is a mere offset amount and correction is not an effective correction. Therefore, the correction term must be decided on the basis of the correction amounts of a statistically effective number of points. Here, when the number of defects to be reviewed to decide the correction term is N and N=total points, all the defects are reviewed according to their sizes and this operation does not invite the drop of through-put. Therefore, optimum N is determined from the statistical aspect. Generally, when the maximum allowable error of the estimation values is e and the value of z corresponding to a required probability is z₀, N can be determined from equation (1) and when this equation is solved, equation (2) is obtained.

$$\begin{matrix}[ Expression 1 ] & \\ {z}_{0} \frac{σ}{\sqrt{N}} = e & ( 1 ) \\ N = {( \frac{{z}_{0} σ}{e} )}^{2} & ( 2 )\end{matrix}$$

When the maximum allowable error e of the estimation value is 0.3 μm and the required probability is 80%, for example, z=1.28. Here, when the standard deviation σ of the defect coordinate error of a wafer is 1.3 μm and is put into equation (2), N=17.3. In other words, as to this wafer, the correction term can be decided by using the correction values of minimum 17 points. As a concrete correction method, the standard deviation α is again calculated whenever the error amount is determined in Step 111, and is put into equation (2). When the calculation result satisfies the following equation (3) at this time, N is not sufficient for deciding the correction term. Therefore, the flow returns to Step 104 and the data of the coordinate error is acquired at other defect points. When the following equation (4) is established, on the other hand, it means that the data of the coordinate error amount of the number of effective points for deciding the correction term is acquired.

$$\begin{matrix}[ Expression 2 ] & \\ N \geq {( \frac{{z}_{0} σ}{e} )}^{2} & ( 3 ) \\ N < {( \frac{{z}_{0} σ}{e} )}^{2} & ( 4 )\end{matrix}$$

A correction formula taking parameters for correcting each factor is incorporated in advance in the apparatus as a method of deciding the correction term. The following equation (5), for example, can be used as a coordinate transformation formula for transforming foreign coordinates (x1, y1) viewed on the coordinate system of the defect inspection apparatus to foreign coordinates (x, y) viewed on the coordinate system of a review apparatus (such as review SEM).

$$\begin{matrix}[ Expression 3 ] & \\ ( \begin{matrix}x \\ y\end{matrix} ) = ( \begin{matrix}m ( cos β + sin βtanα ) & - \frac{n sin β}{cos α} \\ m ( sin β - cos β tan α ) & \frac{n cos β}{cos α}\end{matrix} ) ( \begin{matrix}{x}_{1} \\ {y}_{1}\end{matrix} ) + ( \begin{matrix}c \\ d\end{matrix} ) & ( 5 )\end{matrix}$$

In the equation given above, (c, d) is an origin offset between the coordinate axes, α is an orthogonal error of the coordinates of the inspection apparatus, β is an angular error between the coordinate axes, m is a dimensional accuracy error of an X axis and n is a dimensional accuracy error of a Y axis.

After the correction term (parameters c, d, α, β, m and n in the case of equation (5)) is decided so as to make minimal the error amount of the coordinate value of the defect inspection apparatus and the coordinate value of the review apparatus, the remaining defect points are again sorted on the basis of the shortest distance algorithm in the next Step 113. Here, it is also possible to select a route that makes the total moving distance shorter than when a random route is selected even when the substantially shortest distance covering all the points or the theoretically shortest distance is not taken.

In the next Step 114, the remaining defect points are reviewed. In this instance, the defect coordinate position acquired from the defect inspection apparatus is corrected by using the correction term determined in Step 112. After the flow moves to the next defect point, the observation FOV is changed in accordance with the defect size. At this time, it is believed that the error between the defect coordinates after correction and the actual defect coordinates is small. Therefore, observation can be made with a narrower FOV, that is, with a higher magnification. The set magnification at this time can be changed on the recipe such as 50k times in the case of a defect of 50 nm, for example. However, because the process can be executed by default setting, too, coordinate correction and setting of the magnification can be executed substantially without intervention of people, and through-put as well as automation ratio can be drastically improved.

In the judgment of the next Step 115, the defect review is finished at the point at which the review is made the number of times corresponding to the number of defects set by the recipe.

It should be further understood by those skilled in the art that although the foregoing description has been made on embodiments of the invention, the invention is not limited thereto and various changes and modifications may be made without departing from the spirit of the invention and the scope of the appended claims.

1. A method of observing defects by moving a visual field of a microscope to defect coordinates on a sample acquired by other inspection apparatus, comprising the steps of:
reading defect data inclusive of coordinate information and size information, acquire by said other inspection apparatus;
sorting said defect data in descending order according to a defect size;
moving the visual field to the positions on the sample indicated by the defect coordinates of said defect in order of the defect size from largest to smallest on the basis of the sorting result;
determining an error between the coordinates of the defect observed by moving the visual field and the defect coordinates acquired by said other inspection apparatus; and
calculating a correction term for coordinate transformation for the defect coordinates acquired by said other inspection apparatus by using said coordinate errors accumulated.

2. A method of observing defects according to claim 1, wherein a defect observation number for calculating the correction term for said coordinate transformation is dynamically determined and said coordinate transformation formula is acquired at the point at which the coordinate errors of the number determined are acquired.

3. A method of observing defects according to claim 2, wherein the observation order of the remaining defects is switched from the order of the size of the defects to the observation order attaching importance to through-put after the correction term for said coordinate transformation is derived.

4. A method of observing defects according to claim 3, wherein a condition of at least one of a visual field region, an image size, existence/absence of peripheral retrieval when the defect is not detected, and image processing parameters, is decided on the basis of the size information of the defects.

5. A defect observation apparatus having a screen for displaying an image of a defect by moving a visual field of a microscope to defect coordinates on a sample, comprising a selection portion for automatic setting and manual setting of a recipe condition when an image is acquired by said microscope.

6. A defect observation apparatus according to claim 5, wherein a maximum size can be set when information about the defect is again sorted by the size of said defect when said manual setting is selected.

7. A defect observation apparatus according to claim 6, wherein information of a defect exceeding the maximum size set is positioned after information of the defects sorted again.

8. A defect observation apparatus according to claim 5, which further comprises a calculation portion for sorting again the information about the defect by size of the defects when said manual setting is selected, and calculating an error amount between the position coordinates of the defect and the position coordinates actually detected, and a storage portion for storing the error amount.

9. A defect observation apparatus according to claim 8, wherein the number of defects for determining said error amount is smaller than the total number of the defects detected.

10. A defect observation apparatus according to claim 8, wherein said screen displays the image of a defect on the basis of the coordinates transformed on the basis of said error amount.
